(19) United States
(12) Patent Application Publication
(10) Pub. No.: US 2006/0106501 A1
(43) Pub. Date: May 18, 2006

(54) NEURAL MODELING FOR NOx GENERATION CURVES

(75) Inventors: Richard Gomer, Carson City, NV (US); Bryan Holzbauer, Gardnerville, NV (US); Scott Williams, Minden, NV (US); Shane Jenkins, Minden, NV (US); James A. Maxson, Minden, NV (US); Stephen Kwan, Minden, NV (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/904,491

(22) Filed: Nov. 12, 2004

(51) Int. Cl. G05D 11/00

(52) U.S. Cl. 700/286

(57) ABSTRACT

A method of generating NOx curves over a range of load points includes obtaining current measurements from a respective sensor and validating the current measurements. A plurality of input curves are generated using predefined inputs for each load point. The plurality of input curves include a first set point curve and a second set point curve, where the second setpoint curve includes the first setpoint curve offset with the current measurements. A plurality of NOx curves are generated including a design curve, an adjusted design curve, and a NOx generation curve created by a neural model. The second setpoint curve is passed through the neural model to derive the NOx generation curve. After validating the NOx generation curve and adjusted design curve, one of the plurality of NOx curves is outputted.

### BACKGROUND OF THE INVENTION

A hydrocarbon fuel can be burned in a combustor or combustion system (hereinafter “combustion system”), such as, but not limited to, boilers, furnaces, combustion gas turbines or fossil combustors, to produce heat to raise the temperature of a fluid. Various governmental entities have imposed limits for combustion byproducts/products that operators of combustion systems must fall within for compliance with environmental regulations and design constraints. For the combustion system to operate efficiently and to produce an acceptably “complete” combustion (a combustion where combustion byproducts/products fall within the limits imposed by environmental regulations and design constraints), individual burners of the combustion system should be operating cleanly and efficiently. Further, post-flame combustion control systems should be properly balanced and adjusted so that the combustion system operates in compliance with environmental regulations and design constraints.

Emissions of unburned carbon, nitric oxides (in this application meaning NO, NO₂, NOx), carbon monoxide or other byproducts commonly are monitored to ensure compliance with environmental regulations. As used herein and in the claims, the term nitric oxides shall include nitric oxide (NO), nitrogen dioxide (NO₂), and nitrogen oxide (NOx, where NOx is the sum of NO and NO₂). The monitoring of emissions heretofore has been done, by necessity, on the aggregate emissions from the combustion system. When a particular combustion byproduct is produced at unacceptably high concentrations, the combustion system should be adjusted to restore proper operations.

Utilities typically use static, design curves to illustrate a trend of NOx production of a combustor. In particular, a previous approach includes offsetting the NOx design curve with the current measurement of NOx production. While this methodology captures the gross trend of NOx emissions versus megawatt (MW) power output, the static design curve does not reflect all of the real-time variance in NOx emissions. In particular, the NOx design curve does not account for changes in the shape of the NOx emissions curve itself. Both the magnitude and shape of the curve change as conditions at the utility plant change, such as changes in, for example, boiler cleanliness, ambient temperature, fuel quality, operating procedure, equipment maintenance, amongst numerous other changes.

Physical models are extremely complicated, computationally cumbersome, and generally not accurate when applied to real world conditions. Empirical models are not capable of capturing all of the various parameters and processes that impact the complex phenomena of NOx production. Since most fossil-fired boilers have excellent instrumentation, historical data sets, and well-characterized setpoints that are known to impact NOx, the problem is ideally suited for neural network modeling. Neural network modeling has been used to predict NOx emission at a given megawatt load point, however, it has never been used to produce a NOx emission curve over all megawatt load points or over a full range thereof.

Accordingly, there is a desire to create a predicted NOx emission curve over the full range of megawatt load points on demand based on current measurements.

### BRIEF DESCRIPTION OF THE INVENTION

The above discussed and other drawbacks and deficiencies are overcome or alleviated by a method of generating NOx curves over a range of load points includes obtaining current measurements from a respective sensor and validating the current measurements. A plurality of input curves are generated using predefined inputs for each load point. The plurality of input curves include a first set point curve and a second set point curve, where the second setpoint curve includes the first setpoint curve offset with the current measurements. A plurality of NOx curves are generated including a design curve, an adjusted design curve, and a NOx generation curve created by a neural model. The second setpoint curve is passed through the neural model to derive the NOx generation curve. After validating the NOx generation curve and adjusted design curve, one of the plurality of NOx curves is outputted.

In an alternative embodiment, one or more computer-readable media having computer-readable instructions thereon which, when executed by a computer, cause the computer to: obtain current measurements from a respective sensor; validate the current measurements; generate a plurality of input curves using predefined inputs for each load point, the plurality of input curves including a first set point curve and a second set point curve, the second setpoint curve including the first setpoint curve offset with the current measurements; generate a plurality of NOx curves including a design curve, an adjusted design curve, and a NOx generation curve created by a neural model, wherein the second setpoint curve is passed through the neural model to derive the NOx generation curve; generate a plurality of NOx curves including a design curve, an adjusted design curve, and a NOx generation curve created by a neural model, wherein the first and second setpoint curves are passed through the neural model to derive the NOx generation curve if valid, otherwise the first setpoint curve is passed when the second setpoint curve is invalid; validate the NOx generation curve and adjusted design curve; and output one of the plurality of NOx curves after the validating.

In yet another embodiment, a system for generating NOx curves over a range of load points is disclosed. The system includes: means for obtaining current measurements from a respective sensor; means for validating the current measurements; means for generating a plurality of input curves using predefined inputs for each load point, the plurality of input curves including a first setpoint curve and a second set point curve, the second setpoint curve including the first setpoint curve offset with the current measurements; means for generating a plurality of NOx curves using predefined inputs for each megawatt load point, the plurality of NOx curves including a design curve, an adjusted design curve, and a NOx generation curve created by a neural model, wherein the second setpoint curve is passed through the neural model to derive the NOx generation curve if valid, otherwise the first setpoint curve is passed when the second setpoint curve is invalid; means for validating the NOx generation curve and adjusted design curve; and means for outputting one of the plurality of NOx curves after the validating.

The above-discussed and other features and advantages of the present disclosure will be appreciated and understood by those skilled in the art from the following detailed description and drawings.

### BRIEF DESCRIPTION OF THE FIGURES

The following description of the figures is not intended to be, and should not be interpreted to be, limiting in any way.

FIG. 1 is a flowchart illustrating a method to generate NOx curves using neural network modeling and validation of the same in accordance with an exemplary embodiment;

FIG. 2 is a graph of each NOx break point against tolerance bounds for each megawatt (MW) load point for checking validity of a neural model curve in accordance with an exemplary embodiment; and

FIG. 3 is a graph of a neural model calculated NOx generation curve and an adjusted NOx design curve to check validity of the NOx generation curve in accordance with an exemplary embodiment.

### DETAILED DESCRIPTION OF THE INVENTION

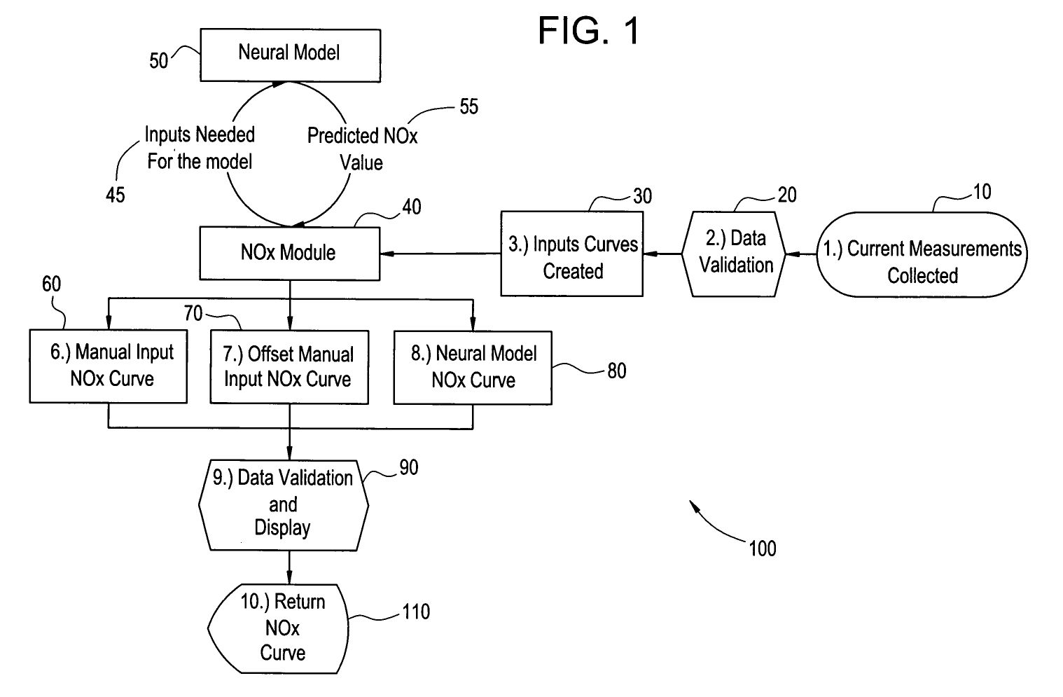

Referring to FIG. 1, neural network modeling can be used to produce NOx generation curves at different megawatt load points for a turbine indicated generally at 100. Artificial neural networks are adaptive models that can learn from the data and generalize things learned. They extract the essential characteristics from the numerical data as opposed to memorizing all of it. This offers a convenient way to reduce the amount of data as well as to form a implicit model without having to form a traditional, physical model of the underlying phenomenon. Artificial neural networks, or shortly, neural networks have been quite promising in offering solutions to problems, where traditional models, have failed or are very complicated to build. Due to the non-linear nature of the neural networks, they are able to express much more complex phenomena than some linear modeling techniques.

The neural network model 100 accepts a number of inputs at different megawatt load points to predict the NOx emissions at each megawatt load point using current measurements for each input into the neural network model. Using each NOx predicted point, the points are combined to create a NOx emission generation curve for the full range of megawatt load points for the turbine. As discussed above, neural network modeling has been used to predict NOx emission at a given megawatt load point, but it has never been used to produce a NOx emission curve over all megawatt load points.

At block 10, current measurements are collected from one or more corresponding sensors configured to measure respective setpoint data. The setpoint data includes, but is not limited to, for example: excess oxygen; coal quality; mill biases; fan biases; burner damper positions; overfire air damper positions; furnace pressure; windbox pressure drop; economizer gas exit temperatures; air heater air exit temperature; superheat and reheat steam temperature and pressure; burner tilts; ambient temperature and pressure; or averaged NOx from a preceding time step.

At block 20, the current measurements are validated and replaced if necessary with appropriate values. For example, if a sensor is damaged, the current measurements can be replaced with a last known good value or a default value.

At block 30, setpoint curves are generated using predefined inputs for each megawatt load point. The setpoint curves are offset with the current measurement to generate an adjusted setpoint curve or an offset setpoint curve. An adjusted setpoint curve is generated for every input into the neural model and passed along with its corresponding design curve to a NOx module indicated at block 40. If the adjusted setpoint curve is found invalid, the generated setpoint curves are used instead.

All of the inputs from the NOx module at block 40 are passed through a neural model at block 50 for a given megawatt load point indicated generally with arrow 45. The neural model at block 50 returns a predicted value of NOx for a given megawatt load point to NOx module at block 40 indicated generally with arrow 55. Arrows 45 and 55 generally indicate that a predicted value of NOx is repeated for all megawatt load points.

At block 60, the design curve is created based on the predefined inputs for NOx at each megawatt load point. At block 70, an adjusted design curve is created by offsetting the predefined NOx design curve of block 60 to pass through the current measured NOx. At block 80, a NOx generation curve is created from the predicted values returned from the neural model of block 50.

At block 90, the NOx generation curve created from the neural model is checked for positive coefficients and verified against the adjusted design curve created at block 70. If the two curves are within defined tolerances, the NOx generation curve created using the neural model is considered good and is returned at block 1 10 as a valid NOx generation curve. If the neural predicted NOx generation curve is out of tolerance, the adjusted design curve created at block 70 is returned as being more valid that the NOx generation curve.

In summary, the neural modeling NOx generation curves calculates real-time NOx production curves by using a neural model tailored and trained for this purpose. The neural model uses key inputs or setpoints that are derived from design curves of block 60 that are offset at block 70 according to their current measured values at the unit. Detailed data validation is employed at block 20 to ensure that the on-line data used in the neural model of block 50 are within defined tolerances. If any of the data are invalid, the method at block 70 which offsets the predefined NOx design curve of block 60 passes through the current measured NOx to be used as a replacement for the NOx generation curve of block 80.

A possible way to calculate the offset, but not limited thereto, is given by:
NOxOffset=NOxₘₑₐₛ−f(NOx(MWₘₑₐₛ))=NOxₘₑₐₛ−(A×MWₘₑₐₛ²+B×MWₘₑₐₛ+C)
where A, B and C are coefficients to a second order polynomial.

To be able to use the on-line neural model of block 50 to calculate the real-time NOx generation curve of block 80, curves of block 60 for each setpoint versus load will be defined as inputs into the model.

In an exemplary embodiment, each of the setpoint curves is then adjusted for the megawatt (MW) load points or breakpoints based on present machine conditions at block 70. The following procedure needs to be done for each setpoint. If the data validation logic variable is set based on the measured data being invalid, the offset should be set to zero so that the defined or design curve of block 60 itself is used. If the logic variable is valid, then one exemplary method to offset or adjust for a specific setpoint is given by:
Offset=Setpointₘₑₐₛ−f(Setpoint(MWₘₑₐₛ))=Setpointₘₑₐₛ−(A×MWₘₑₐₛ²+B×MWₘₑₐₛ+C)
where A, B and C are coefficients to a second order polynomial.

To ensure that this calculated offset does not produce a resultant setpoint curve that has a value outside of its bounds, a check is performed using an appropriate curve fitting of empirical data, such as a parabolic curve fit, for example. The curve fit is used to determine where a minima is in the curve, which will then be checked to see if the minima is outside of the tolerance:

One exemplary method to verify this, but not limited thereto, is given by:
d(A×MWₘₑₐₛ²+B×MWₘₑₐₛ+C)/dMW=0
2 A MW_{meas,min}+B=0
MW_{meas,min}=−B/(2×A)

Hence the minimum or maximum setpoint value can be calculated by:
Setpointₘᵢₙ=Offset+(A×MW_{meas,min}²+B×MW_{meas,min}+C)

If this value is not within the tolerance, the offset will be set to zero. If more than one of the setpoints is out tolerance, the adjusted NOx design curve of block 70 is used as a replacement.

If the value is within tolerance, the offset design curve of block 30 is passed on to the neural model calculation indicated at block 50 to derive the NOx generation curve of block 80.

Data validation at block 90 is mandatory for neural model accuracy. Data validation and replacement routines must be used for every setpoint and the NOx data used in the model indicated at block 20.

Data validation at block 90 makes certain that the NOx generation curve created at block 80 by the neural model indicated at block 50 is valid. Several checks are done to ensure that this is the case. Furthermore, data validation at block 90 is needed to prevent the largest occurring problem when using neural models: the known fact that they will always provide an answer, even if that answer is nonsensical because it is based on data in a regime for which it has not been trained. Block 90 may further include displaying the validation of curves at block 90. Block 110 then displays a valid result for real-time NOx emission. In an exemplary embodiment, displaying of blocks 90 and 110 may include using a display device indicated at 154 in FIG. 4.

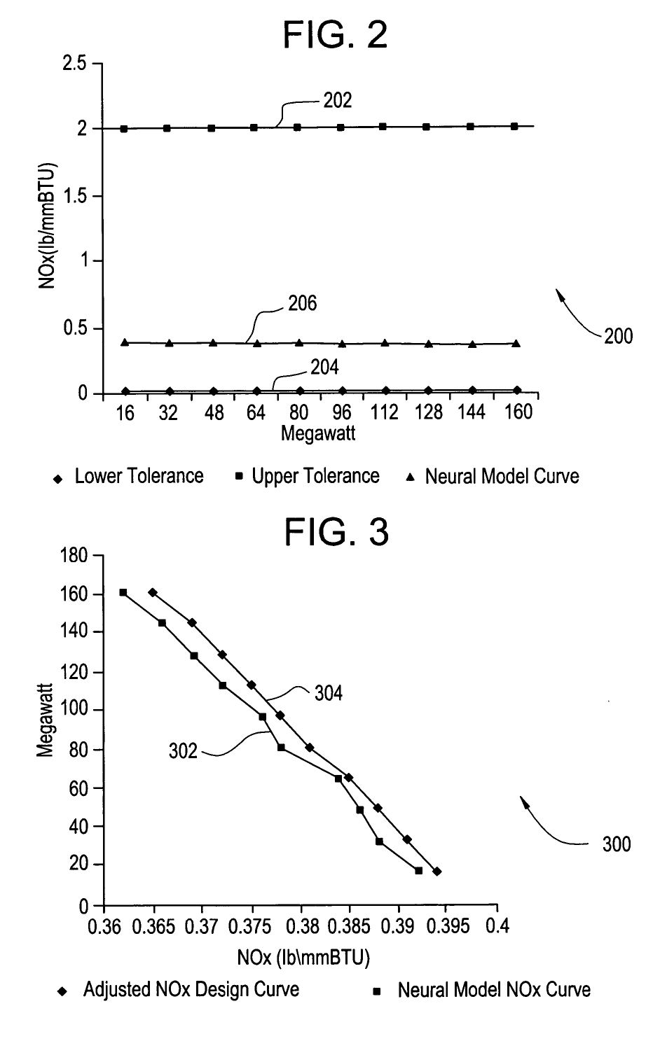

Referring now to FIG. 2, a first check includes validating each NOx breakpoint or load point against the tolerance bounds for NOx at a respective load point. If any of the breakpoints are outside the bounds, the adjusted NOx design curve of block 70 is used as a replacement. FIG. 2 illustrates a graph 200 of NOx emission versus megawatts. A first curve 202 illustrates an upper tolerance curve depicting the upper bounds, while a second curve 204 illustrates a lower tolerance curve depicting the lower bounds. A third curve 206 intermediate first and second curves 202 and 204, respectively, illustrates a neural model curve within the upper and lower bounds.

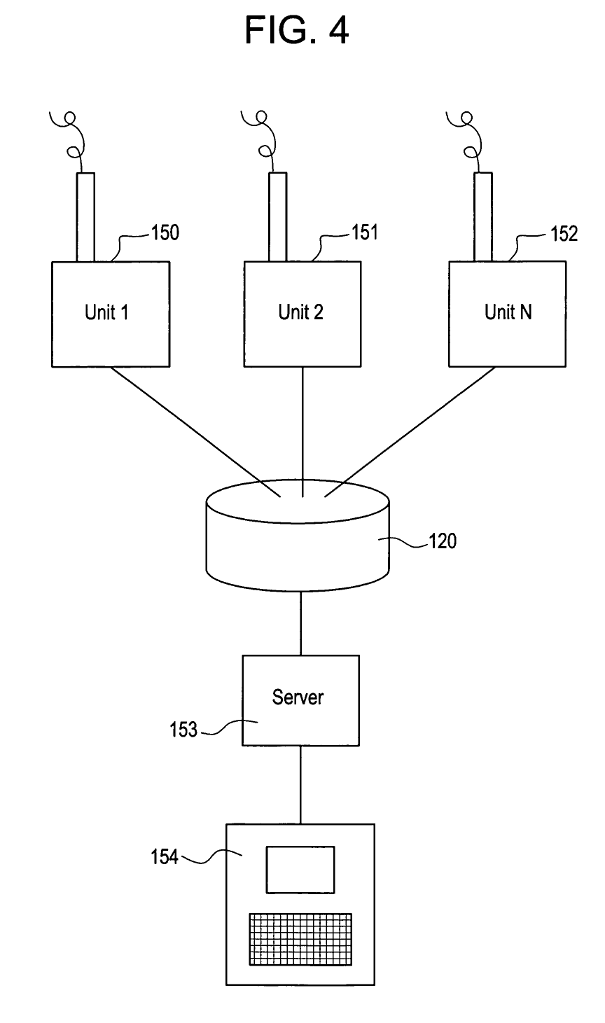

Referring now to FIG. 3, after validating each NOx breakpoint or load point against the tolerance bounds for NOx, the neural model calculated NOx generation curve of block 80 is compared with the adjusted NOx design curve of block 70 indicated generally at graph 300. Graph 300 depicts megawatt load points versus NOx emission. In particular, graph 300 illustrates the neural model calculated NOx generation curve of block 80 indicated at 302, while the adjusted NOx design curve of block 70 is indicated at 304. One factor to check includes verifying that a trend of curve 302 is correct relative to curve 304. More specifically, verifying the trend includes verifying that a slope of both curves is substantially the same or has the same negative or positive slope (e.g., right sign).

In an exemplary embodiment, one method to assess that the slopes are either both positive or negative includes creating parabolic curve fits for both curves 302, 304 and verifying that the sign of the first and second order coefficients are the same, e.g.,
NOx_{adjusted}=(A×MW²+B×MW+C)
NOxₙₑᵤᵣₐₗ=(A′×MW²+B′×MW+C′)
If ((((A>0) and (A′<0)) or ((A<0) and (A′>0))) or (((B>0) and (B′<0)) or ((B<0) and (B′>0))) then

logic=false,

else

logic=true.

If the logic variable above is “false”, the neural curve 302 should be rejected and the adjusted NOx design curve 304 is used as a replacement.

For a user or a power company acting as a seller, a number of advantages accrue from the above, some of which are discussed below. For example, instead of relying on a human generated best guess to forecast reasonable NOx emissions at any megawatt load point in a range of megawatt load points, and thus for the power company to be economically successful in estimating such emissions, neural network modeling can be relied on instead. This leads to more accurate and thus more successful estimates of NOx emission. Neural modeling will be used to produce NOx generation curves at different megawatt load points for a turbine. The neural model will accept a number of inputs at different megawatt load points to predict the NOx emissions at each megawatt load point using current measurements for each input into the neural model. Using each NOx predicted point the points will be combined to create a NOx emission generation curve for the full range of megawatt load points for the turbine. Thus, one advantage accrued by the above disclosure is to create a predicted NOx emission generation curve over the full range of megawatt load points on demand based on current measurements.

As shown in FIGS. 1-4, the present system, methods, and apparatus, may be embodied as software and/or hardware in a computer system as a software program or product code for any desired number of power generation units (150-152) having a user interface 154 and having access to a current measurement and setpoint database 120. The embodiments described herein are is not limited to any particular type of fuel source or type of power generation unit or plant, including nuclear, fossil fuel plants including oil and gas plants, geothermal, solar, hydroelectric, wind power or other fuel source.

FIG. 4 illustrates an example of a suitable computing system environment in which the methods and apparatus described above and/or claimed herein may be implemented. The computing system environment is only one example of a suitable computing environment and is not intended to suggest any limitation as to the scope of use or functionality of the invention. Neither should the computing environment shown in FIG. 4 be interpreted as having any dependency or requirement relating to any one or combination of components illustrated in the exemplary operating environment in FIG. 4.

One of ordinary skill in the art can appreciate that a computer or other client or server device can be deployed as part of a computer network, or in a distributed computing environment. In this regard, the methods and apparatus described above and/or claimed herein pertain to any computer system having any number of memory or storage units, and any number of applications and processes occurring across any number of storage units or volumes, which may be used in connection with the methods and apparatus described above and/or claimed herein. Thus, the same may apply to an environment with server computers and client computers deployed in a network environment or distributed computing environment, having remote or local storage. The methods and apparatus described above and/or claimed herein may also be applied to standalone computing devices, having programming language functionality, interpretation and execution capabilities for generating, receiving and transmitting information in connection with remote or local services.

The methods and apparatus described above and/or claimed herein is operational with numerous other general purpose or special purpose computing system environments or configurations. Examples of well known computing systems, environments, and/or configurations that may be suitable for use with the methods and apparatus described above and/or claimed herein include, but are not limited to, personal computers, server computers, hand-held or laptop devices, multiprocessor systems, microprocessor-based systems, network PCs, minicomputers, mainframe computers, distributed computing environments that include any of the above systems or devices.

The methods described above and/or claimed herein may be described in the general context of computer-executable instructions, such as program modules, being executed by a computer. Program modules typically include routines, programs, objects, components, data structures, etc. that perform particular tasks or implement particular abstract data types. Thus, the methods and apparatus described above and/or claimed herein may also be practiced in distributed computing environments such as between different power plants or different power generator units (150-152) where tasks are performed by remote processing devices that are linked through a communications network or other data transmission medium. In a typical distributed computing environment, program modules and routines or data may be located in both local and remote computer storage media including memory storage devices. Distributed computing facilitates sharing of computer resources and services by direct exchange between computing devices and systems. These resources and services may include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the methods and apparatus described above and/or claimed herein.

Computer programs implementing the method described above will commonly be distributed to users on a distribution medium such as a CD-ROM. The program could be copied to a hard disk or a similar intermediate storage medium. When the programs are to be run, they will be loaded either from their distribution medium or their intermediate storage medium into the execution memory of the computer, thus configuring a computer to act in accordance with the methods and apparatus described above.

The term “computer-readable medium” encompasses all distribution and storage media, memory of a computer, and any other medium or device capable of storing for reading by a computer a computer program implementing the method described above.

Thus, the various techniques described herein may be implemented in connection with hardware or software or, where appropriate, with a combination of both. Thus, the methods and apparatus described above and/or claimed herein, or certain aspects or portions thereof, may take the form of program code or instructions embodied in tangible media, such as floppy diskettes, CD-ROMs, hard drives, or any other machine-readable storage medium, wherein, when the program code is loaded into and executed by a machine, such as a computer, the machine becomes an apparatus for practicing the methods and apparatus of described above and/or claimed herein. In the case of program code execution on programmable computers, the computing device will generally include a processor, a storage medium readable by the processor which may include volatile and non-volatile memory and/or storage elements, at least one input device, and at least one output device. One or more programs that may utilize the techniques of the methods and apparatus described above and/or claimed herein, e.g., through the use of a data processing, may be implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of described above and/or claimed herein may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or a receiving machine having the signal processing capabilities as described in exemplary embodiments above becomes an apparatus for practicing the method described above and/or claimed herein. When implemented on a general-purpose processor, the program code combines with the processor to provide a unique apparatus that operates to invoke the functionality of the methods and apparatus of described above and/or claimed herein. Further, any storage techniques used in connection with the methods and apparatus described above and/or claimed herein may invariably be a combination of hardware and software.

While the methods and apparatus described above and/or claimed herein have been described in connection with the preferred embodiments and the figures, it is to be understood that other similar embodiments may be used or modifications and additions may be made to the described embodiment for performing the same function of the methods and apparatus described above and/or claimed herein without deviating therefrom. Furthermore, it should be emphasized that a variety of computer platforms, including handheld device operating systems and other application specific operating systems are contemplated, especially given the number of wireless networked devices in use.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

What is claimed is:

1. A method of generating NOx curves over a range of load points, the method comprising:
obtaining current measurements from a respective sensor;
validating the current measurements;
generating a plurality of input curves using predefined inputs for each load point, the plurality of input curves including a first setpoint curve and a second set point curve, the second setpoint curve including the first setpoint curve offset with the current measurements;
generating a plurality of NOx curves including a design curve, an adjusted design curve, and a NOx generation curve created by a neural model, wherein the second setpoint curve is passed through the neural model to derive the NOx generation curve;
validating the NOx generation curve and adjusted design curve; and
outputting one of the plurality of NOx curves after the validating.

2. The method of claim 1, wherein the design curve is generated based on predefined inputs for NOx at each megawatt load point, the adjusted design curve is generated by offsetting the design curve to pass through a current measured NOx, and the NOx generation curve is created from predicted values returned from the neural model.

3. The method of claim 1, wherein the NOx generation curve is outputted if valid and the adjusted design curve is invalid.

4. The method of claim 1, wherein the adjusted design curve is outputted if valid and the NOx generation curve is invalid.

5. The method of claim 1, wherein the design curve is outputted if valid and the adjusted design curve and the NOx generation curve are both invalid.

6. The method of claim 1, wherein validation of the current measurements includes validating each NOx load point against predefined tolerance bounds for NOx.

7. The method of claim 1, wherein the NOx generation curve is validated against the adjusted design curve by checking a trend of slopes for each curve.

8. The method of claim 7, wherein checking the trend of slopes for each curve includes creating curve fits for both curves and checking whether a sign of all higher order polynomial coefficients are the same.

9. The method of claim 8, wherein when the sign is the same, the NOx generation curve is output, if not, the adjusted design curve is outputted.

10. The method of claim 1, wherein the validating the current measurements includes replacing a current measurement with an appropriate value if necessary.

11. The method of claim 10, wherein the appropriate value includes at least one of a last known good value and a default value.

12. The method of claim 1, wherein creating the NOx generation curve by the neural model includes: passing all inputs for a corresponding load point through the neural model; and generating a predicted value of NOx for the corresponding load point for all load points in a selected megawatt load point range.

13. The method of claim 12, wherein the inputs to the neural model include setpoints derived from a corresponding design curve that is offset according to values of the current measurements.

14. The method of claim 13, wherein setpoints include at least one of:
excess oxygen;
coal quality;
mill biases;
fan biases;
burner damper positions;
overfire air damper positions;
furnace pressure;
windbox pressure drop;
economizer gas exit temperatures;
air heater air exit temperature;
superheat and reheat steam temperature and pressure;
burner tilts;
ambient temperature and pressure; and
averaged NOx from a preceding time step.

15. The method of claim 13, wherein an offset to a corresponding design curve is set to zero when the current measurements are invalid so that the design curve itself is outputted.

16. The method of claim 1, wherein each design curve for each load point is adjusted based on present conditions to generate the corresponding adjusted design curve.

17. The method of claim 1, wherein the first setpoint curve is passed through the neural model to derive the NOx generation curve when the second setpoint curve is invalid.

18. One or more computer-readable media having computer-readable instructions thereon which, when executed by a computer, cause the computer to:
obtain current measurements from a respective sensor;
validate the current measurements;
generate a plurality of input curves using predefined inputs for each load point, the plurality of input curves including a first set point curve and a second set point curve, the second setpoint curve including the first setpoint curve offset with the current measurements;
generate a plurality of NOx curves including a design curve, an adjusted design curve, and a NOx generation curve created by a neural model, wherein the second setpoint curve is passed through the neural model to derive the NOx generation curve;
generate a plurality of NOx curves including a design curve, an adjusted design curve, and a NOx generation curve created by a neural model, wherein the first and second setpoint curves are passed through the neural model to derive the NOx generation curve if valid, otherwise the first setpoint curve is passed when the second setpoint curve is invalid;
validate the NOx generation curve and adjusted design curve; and output one of the plurality of NOx curves after the validating.

19. The one or more computer-readable media of claim 18, wherein the design curve is generated based on predefined inputs for NOx at each megawatt load point, the adjusted design curve is generated by offsetting the design curve to pass through a current measured NOx, and the NOx generation curve is created from predicted values outputted from the neural model.

20. The one or more computer-readable media of claim 18, wherein the NOx generation curve is output if valid over the adjusted design curve, the adjusted design curve is output if valid and the NOx generation curve is invalid, and the design curve is output if the adjusted design curve and the NOx generation curve are both invalid.

21. The one or more computer-readable media of claim 18, wherein validation of the current measurements includes validating each NOx load point against predefined tolerance bounds for NOx.

22. The one or more computer-readable media of claim 18, wherein the NOx generation curve is validated against the adjusted design curve by checking a trend of slopes for each curve.

23. The one or more computer-readable media of claim 22, wherein checking the trend of slopes for each curve includes creating curve fits for both curves and checking whether a sign of all higher order polynomial coefficients are the same.

24. The one or more computer-readable media of claim 18, wherein creating the NOx generation curve by the neural model includes: passing all inputs for a corresponding load point through the neural model; and generating a predicted value of NOx for the corresponding load point for all load points in a selected megawatt load point range.

25. A system for generating NOx curves over a range of load points comprising:
means for obtaining current measurements from a respective sensor;
means for validating the current measurements;
means for generating a plurality of input curves using predefined inputs for each megawatt load point, the plurality of input curves including a first setpoint curve and a second set point curve, the second setpoint curve including the first setpoint curve offset with the current measurements;
means for generating a plurality of NOx curves using predefined inputs for each megawatt load point, the plurality of NOx curves including a design curve, an adjusted design curve, and a NOx generation curve created by a neural model, wherein the second setpoint curve is passed through the neural model to derive the NOx generation curve if valid, otherwise the first setpoint curve is passed when the second setpoint curve is invalid;
means for validating the NOx generation curve and adjusted design curve; and
means for outputting one of the plurality of NOx curves after the validating.

26. The system of claim 25, wherein the design curve is generated based on predefined inputs for NOx at each megawatt load point, the adjusted design curve is generated by offsetting the design curve to pass through a current measured NOx, and the NOx generation curve is created from predicted values returned from the neural model.

27. The system of claim 25, wherein the NOx generation curve is outputted if valid over the adjusted design curve, the adjusted design curve is outputted if valid and the NOx generation curve is invalid, and the design curve is outputted if valid and the adjusted design curve and the NOx generation curve are both invalid.

28. The system of claim 25, wherein creating the NOx generation curve by the neural model includes:
passing all inputs for a corresponding load point through the neural model; and generating a predicted value of NOx for the corresponding load point for all load points in a selected megawatt load point range.
